(19) United States
(12) Patent Application Publication
(10) Pub. No.: US 2017/0138552 A1
(43) Pub. Date: May 18, 2017

(54) LINEAR CONFIGURATION LIGHTING MODULE AND APPLICATION THEREOF

(71) Applicants: Thomas E. Stack, Oxford, MI (US); David Douglas, Oak Park, MI (US)

(72) Inventors: Thomas E. Stack, Oxford, MI (US); David Douglas, Oak Park, MI (US)

(21) Appl. No.: 14/941,535

(22) Filed: Nov. 13, 2015

(51) Int. Cl. F21S 4/28; F21V 23/00; F21V 15/015; A47F 3/04; F21V 3/04; F21V 23/06; A47F 11/10; A47F 3/00; F21V 19/00; F21V 7/00

(52) U.S. Cl. CPC F21S 4/28; F21V 19/003; F21V 23/002; F21V 15/015; F21V 7/00; F21V 3/0409; F21V 23/06; A47F 11/10; A47F 3/001; A47F 3/0404; F21Y 2115/10

(57) ABSTRACT

A display case having end jamb lighting module and a center mullion lighting module is disclosed. The lighting modules include a shell and at least one substrate whereon lighting elements are mounted. The shell defines engagement slots used to affix the substrate to the shell. The shell defines an aperture allowing light from the lighting elements to be projected out. The lighting module may include a second substrate upon which electrical components are mounted, the electrical components for conditioning input power for the lighting elements. A reflective portion of the shell or a separate reflector mounted on the shell operates on the light to form a desired spatial distribution of light. An optical cover covers the aperture. The center mullion lighting module can include a third substrate for mounting of lighting elements. Alternatively, the center mullion lighting module can be formed by combining two end jamb lighting modules.

### REFERENCE TO RELATED APPLICATIONS

This application is a Continuation-In-Part application of a current pending U.S. application Ser. No. 13/051,598, filed on Mar. 18, 2011, entitled, “Linear Configuration Lighting Module and application Thereof”, the entirety of which is incorporated by reference herein and priority of which is claimed herein.

The Ser. No. 13/051,598 application, in turn, claims benefit of U.S. application Ser. No. 12/976,922, filed on Dec. 22, 2010, entitled, “Multiple Positioned Light Source to Achieve Uniform or Graded Illumination,” the entirety of which is incorporated by reference herein and priority of which is claimed herein.

The Ser. No. 12/976,922 application, in turn, claims benefit of U.S. application Ser. No. 11/973,430, filed on Oct. 9, 2007, entitled “Multiple Positioned Light Source to Achieve Uniform or Graded Illumination,” the entirety of which is incorporated by reference herein and priority of which is claimed herein.

The Ser. No. 11/973,430 application, in turn, claims the benefit of the filing date of U.S. Provisional Patent Application No. 60/850,030 filed Oct. 6, 2006 entitled “Multiple Positioned Point Sources to Achieve Uniform or Graded Illumination” under 35 USC sections 119 and 120, and said Provisional Patent Application also being incorporated herein by reference and priority of which is claimed herein.

Additionally, this application claims the benefit of the filing date of U.S. Provisional Patent Application No. 61/315,946 filed Mar. 20, 2010 entitled “Linear Configuration Lighting Module” under 35 USC sections 119 and 120; the entirety of the Provisional Application 61/315,946 is incorporated by reference herein, and the priority is claimed herein.

### BACKGROUND

The present invention relates to various aspects of lighting systems. In particular, the present invention relates lighting systems and illumination of partially or fully or enclosed spaces such as product display cases, grocery canopy, and under-shelf lighting in various display appliances.

The use of fluorescent lamps and lighting technology is well known in the lighting art. However, disadvantages of a fluorescent lamp and its ballast include the emission of heat as a side effect, which is counterproductive for use with a cooling apparatus. Further, unsafe conditions may occur in a fluorescent lighting system, including the possibility of high voltage arcing, which could either directly harm the installer, customers, or bystanders, or indirectly by starting a fire. The use of mercury in a fluorescent lamp poses a health hazard to store employees, customers or final consumers due to accidental breakage of a lamp allowing the mercury to contaminate the cabinet interior or product surfaces. Finally, fluorescent bulbs have a limited lifetime, requiring inconvenient replacement.

Attempts have been made in the art toward energy efficient solid state lighting such as light emitting devices (LED's). However, the existing lighting systems are wanting in a number of aspects including, for example, structural shortcoming, lack of modularity, difficulty in manufacture, high costs of manufacture, lack of uniformity in illumination, or a combination of any of these and other deficiencies.

Accordingly, there remains a need for an improved illumination system and technology for more uniform or controlled gradient illumination of substantially enclosed spaces.

### SUMMARY

The need is met by the present invention. In a first embodiment of the present invention, a display case includes panels that define at least partially enclosed space. The display case has a first end jamb and a first end jamb lighting module running along the first end jamb. The first end jamb lighting module includes a lighting module shell, a first substrate affixed to the shell, and lighting elements mounted on the first substrate. The lighting elements can be, for example, light emitting diodes.

In the display case, the panels define a second end jamb and a center mullion. A second end jamb lighting module runs along the second end jamb. A center mullion lighting module runs along the center mullion. The second end jamb lighting module includes a shell, a first substrate affixed to the shell, and lighting elements mounted on said first substrate.

In some embodiments, the center mullion lighting module includes a third end jamb lighting module oriented in a first direction, and a fourth end jamb lighting module mounted proximal to said third end jamb lighting module. The fourth end jamb module is oriented in a second direction.

In other embodiments, the center mullion lighting module includes a shell, a first substrate, a second substrate, and a third substrate, all substrates affixed to the shell. Lighting elements are mounted on the first substrate. Electrical components are mounted on the second substrate, the electrical components connected to the lighting elements of the first substrate. Lighting elements are mounted on the third substrate.

In the display case, the shell defines a plurality of engagement slots such that the first substrate is affixed to the shell by placing portions of the first substrate within the engagement slots. In the display case, the first end jamb lighting module includes a second substrate affixed to the shell and electrical components mounted on the second substrate, the electrical components connected to the lighting elements of the first substrate. The substrates can be affixed to the shell using other methods such as, for example, screws, adhesive, or clips.

In the display case, the shell defines an aperture through which light from the lighting elements is projected, and a reflective surface is located proximal to the aperture.

Alternatively to the reflective surface, or in combination with it, the shell defines an aperture through which light from the lighting elements is projected, and the first end jamb lighting module includes a reflector positioned proximal to the aperture. The reflector is adapted to reflect light from the lighting elements in a desired direction or in a desired spatial distribution.

In the display case, the shell defines an aperture through which light from the lighting elements is projected and the first end jamb lighting module includes an optical cover covering at least a portion of the aperture. The shell may also define a cover tuck insert to which a portion of the cover engages.

In the display case, the first lighting module includes a quick-disconnect connector adapted to engage with a mated connector through which external electrical power is supplied to the first lighting module.

In a second embodiment of the present invention, a display case includes panels defining at least partially enclosed space, the panels also defining a first end jamb, a second end jamb, and a center mullion. A first end jamb lighting module runs along the first end jamb. A second end jamb lighting module runs along the second end jamb. A center mullion lighting module runs along the center mullion. Each lighting module includes a lighting module shell; a first substrate affixed to the shell; and lighting elements mounted on the shell.

Each lighting module further includes a second substrate affixed to the shell and electrical components mounted on the second substrate, the electrical components connected to the lighting elements. Further, each shell defines at least one aperture, and each lighting module includes a reflective surface proximal to the aperture.

In a third embodiment of the present invention, a lighting module includes a lighting module shell, the shell defining at least one engagement slot; a first a substrate affixed to the shell at the engagement slot; and lighting elements mounted on the substrate. In the lighting module, the shell includes a reflector flange portion for supporting a reflector adapted to reflect light from the lighting elements toward a desired direction. Alternatively, the reflector flange portion can be adapted to reconfigure the spatial distribution of light from the lighting elements.

In the lighting module, the shell defines a cover flange; the shell defines a tuck insert; and an optical cover partially wraps around the cover flange and edge of the optical cover is inserted into the tuck insert. The lighting module further includes a first end plate fastened to a first end of the shell, and a second end plate fastened to a second end of the shell.

In a fourth embodiment of the present invention, a lighting module includes a lighting module shell, the shell defining at least one engagement slot; a first a substrate affixed to the shell at the engagement slot; and lighting elements mounted on the substrate.

In the lighting module, the shell defines a cover flange; the shell defines a tuck insert; and an optical cover partially wraps around the cover flange and edge of the optical cover is inserted into the tuck insert. The lighting module further includes a first end plate fastened to a first end of the shell, and a second end plate fastened to a second end of the shell.

In the lighting module, an end plate features a gap through which one or more wires may be routed. The purpose of the gap is to facilitate routing of at least one wire from a fixed location inside the module to another fixed location near the exit from the module. A fixed routing facilitated by this gap serves several purposes. A wire extending for some distance from a module can get fatigued from bending due to external forces being imposed on it. As a result the wire could break, or water could ingress. Also for convenience of assembling the cabinet and its modules, a shorter wiring path may be preferable.

In conjunction with this type of end plate featuring a gap, a cabinet mounting point or surface near the end plate may need to be adapted to receive one or more wires emerging from the module.

### BRIEF DESCRIPTION OF THE DRAWINGS

FIG. 1 is a front perspective view of a display case according to one embodiment of the present invention;

FIG. 2 is a rear perspective view of the display case of FIG. 1;

FIG. 3 illustrates a cut-away top view of the display case of FIGS. 1 and 2 cut along plane A-A;

FIG. 4 is a perspective view of a lighting module according to another embodiment of the present invention;

FIG. 5 is a top view of the lighting module of FIG. 4;

FIGS. 6 and 7 are end views of the lighting module of FIG. 4;

FIG. 8 is a perspective exploded view of a portion of the lighting module of FIG. 4;

FIG. 9 is a cut away cross sectional view of the lighting module of FIG. 4 cut along line C-C illustrated in FIG. 5;

FIG. 10 is a portion of the cut away cross sectional view of the lighting module of FIG. 4 cut along line C-C illustrated in FIG. 5;

FIG. 11 illustrates an alternative embodiment of portions of the lighting module of FIG. 4;

FIG. 12 is a cut away cross sectional view of the portion illustrated in FIG. 11 with additional elements;

FIG. 13 is a perspective view of a lighting module according to yet another embodiment of the present invention;

FIG. 14 is a top view of the lighting module of FIG. 13;

FIG. 15 is a perspective exploded view of portion D of the lighting module of FIG. 13;

FIG. 16 is a cut away cross sectional view of the lighting module of FIG. 13 cut along line E-E illustrated in FIG. 14;

FIG. 17 is a portion of the cut away cross sectional view of the lighting module of FIG. 13 cut along line E-E illustrated in FIG. 14;

FIG. 18 illustrates an alternative embodiment of a portion of the lighting module of FIG. 13;

FIG. 19 illustrates an alternative embodiment of a portion of the display case of FIGS. 1 and 2;

FIG. 20a illustrates a plan view of an alternative end cap joined with a lighting module portion;

FIGS. 20b and 20c show perspective views of the alternative end cap; FIG. 20d illustrates a cut away cross sectional view of the alternative end cap joined with a lighting module portion, cut along line G-G of FIG. 20a;

FIG. 21a shows a plan view of an alternative end cap joined with a lighting module portion, with wires passing through; FIG. 21b illustrates the end cap in perspective along with wires; FIG. 21c illustrates a side cutaway view of an end cap joined to a lighting module along with wires and a support structure; and

FIGS. 22a through 22c show similar views to FIGS. 21a through 22c, though with a filler material in place along various portions.

### DETAILED DESCRIPTION

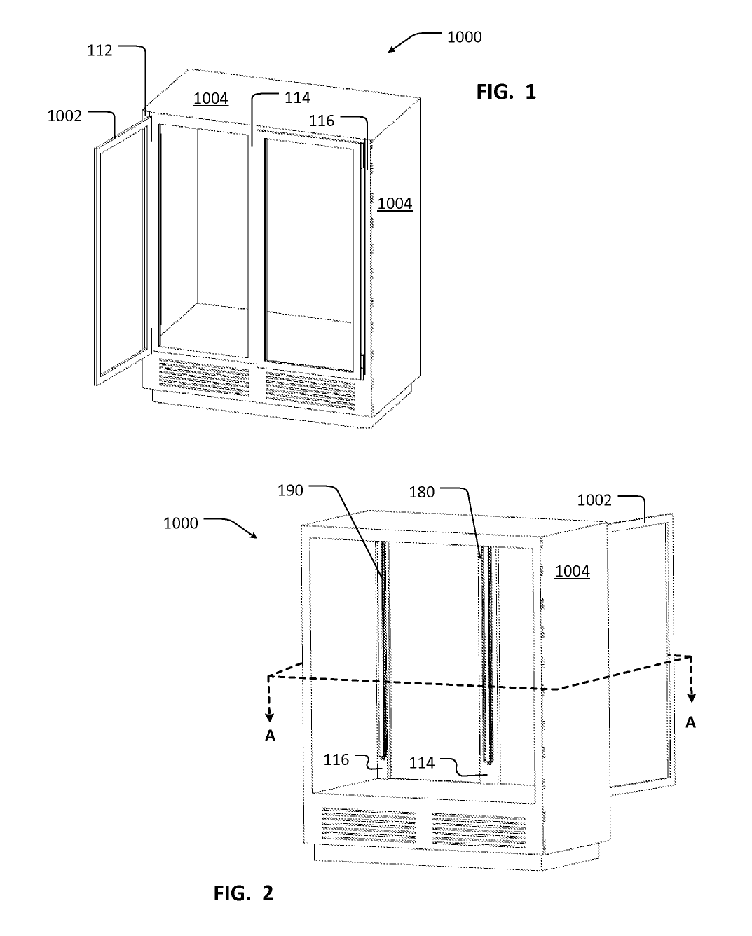

The present invention will now be described with reference to the FIGS. 1 through 22 which illustrate various aspects, embodiments, or implementations of the present invention. In the Figures, some sizes of structures, portions, or elements may be exaggerated relative to sizes of other structures, portions, or elements for illustrative purposes and, thus, are provided to aid in the illustration and the disclosure of the present invention.

FIG. 1 is a front perspective view of a display case 1000 according to one embodiment of the present invention. FIG. 2 is a rear perspective view of the display case of FIG. 1 but without a back panel such that the partial interior view is possible. Referring to FIGS. 1 and 2, according to the illustrated aspect of the present invention, the display case 1000 includes a number of panels such as top and side panels 1004, and doors or windows 1002 either of which may be openable. The display case 1000 is illustrated as defining a substantially enclosed space. The present invention is applicable to many contexts and appliances such as, for example, grocery display fixtures in supermarkets; salad display stations at restaurants.

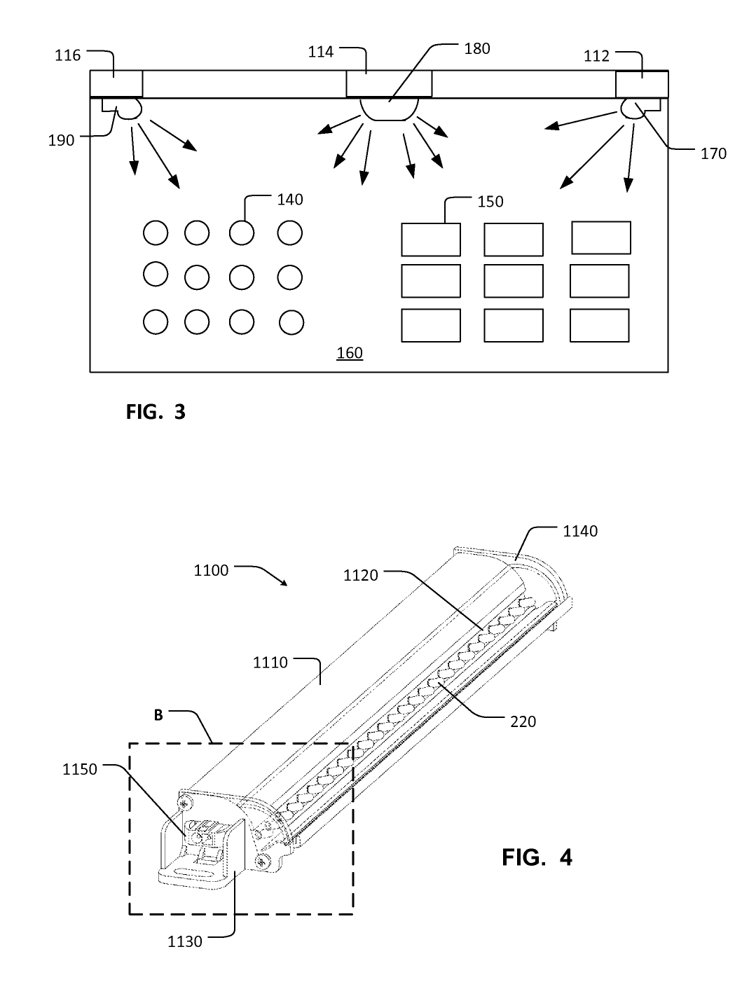

FIG. 3 illustrates a cut-away top view of the display case 1000 cut along plane A-A of FIG. 2 looking downward including a shelf 160. Referring now to FIGS. 1 through 3, the shelf 160 is not illustrated in FIGS. 1 and 2 to avoid clutter in these Figures; however, it is expected that the display case 1000 would enclose a plurality of shelves on which a number of products 140 and 150 are placed and displayed. The products 140 and 150 are shown for illustrative purposes only and illumination for other product selection and layout is within the scope of this development.

Referring to FIGS. 1 through 3, the panels 1004 and doors or windows 1002 meet to define mullions, end jambs, or corners. The outermost vertical members 112 and 116, providing support at the panels 1004 of the display case 1000 are referred to as end jambs. Inner vertical member 114 dividing between window or door partitions is referred to as center mullion 114. The display case 1000 has a first end jamb 112 and a second end jamb 116.

At each of the end jambs 112 and 116, an end jamb lighting module runs along the end jamb. As illustrated, a first end jamb lighting module 170 runs along the first end jamb 112, and a second end jamb lighting module 190 runs along the second end jamb 116. A center lighting module 180 runs along the center mullion 114.

### End Jamb Lighting Module

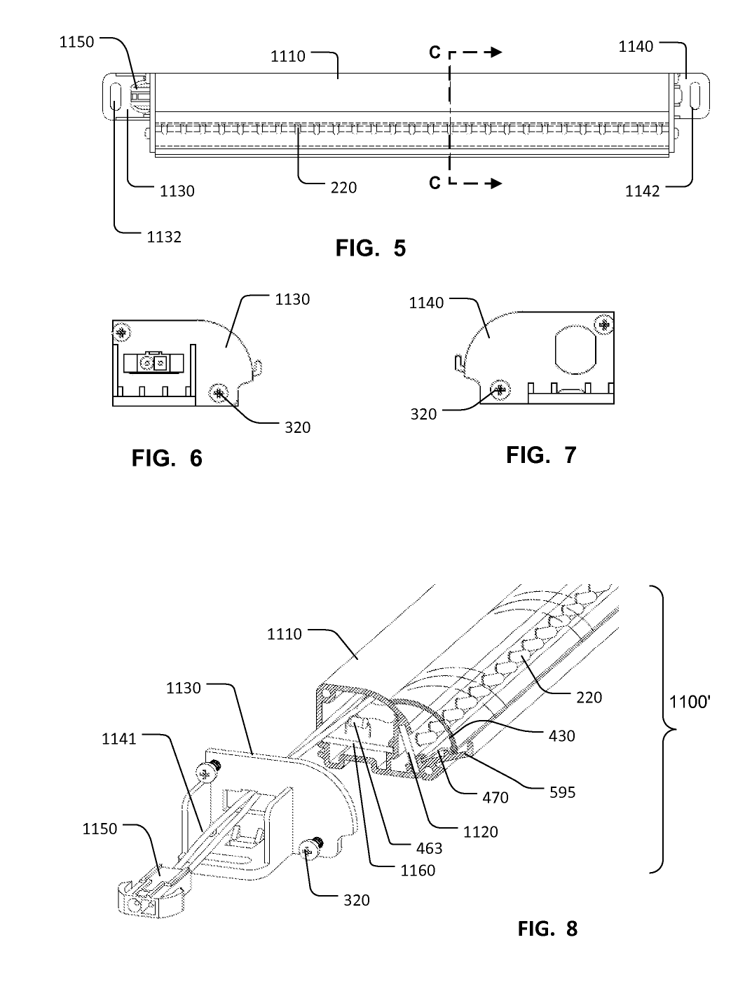

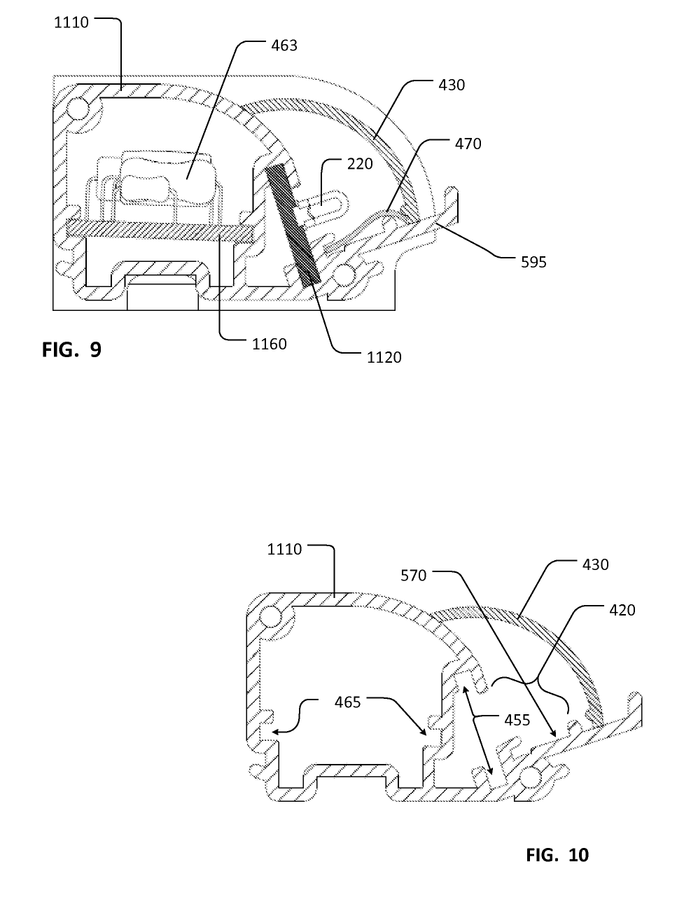

FIG. 4 is a perspective view of an end jamb lighting module in accordance with another embodiment of the present invention. FIG. 5 is a top view of the lighting module of FIG. 4. FIGS. 6 and 7 are views of end portions of the lighting module of FIG. 4. FIG. 8 is an exploded illustration of portion B of the lighting module of FIG. 4. FIG. 9 is a cut-away cross sectional view of the lighting module of FIG. 4 cut at line C-C. FIG. 10 is a cut-away cross sectional view of the lighting module of FIG. 4 cut at line C-C but showing only selected portions of the lighting module.

Referring to FIGS. 4 through 10, an end jamb lighting module 1100 in accordance with another embodiment of the present invention is shown. The end jamb lighting module 1100 corresponds to the lighting modules 170 and 190 in FIGS. 1 through 3. The lighting modules 170 and 190 of FIGS. 1 through 3 have similar construction. The end jamb lighting module includes a lighting module shell 1110, a first substrate 1120, and lighting elements 220. End cap plates 1130 and 1140 cap the ends of the lighting module 1100. The first end cap plate 1130 is fastened to the first end of the shell 1110. The second end cap plate 1140 is fastened to the second end of the shell 1110. The end caps 1130 and 1140 may be made of polyvinyl chloride (PVC), metal or other suitable material. An extrusion process may produce the shell 1110.

The first substrate 1120 can be a printed circuit board (PCB). The lighting elements 220 are, for example, LEDs 220, and are mounted on the first substrate 1120. The first substrate 1120 is affixed to the shell 1110. Devices and means for affixing the first substrate 1120 to the shell 1110 can vary. For example only, the first substrate 1120 can be screwed to the shell 1110, attached using adhesives to the shell 1110, or clipped to the shell 1110.

In the illustrated embodiment, the shell 1110 defines a plurality of engagement slots 455 and 465 such that the first substrate is 1120 affixed to the shell 1110 by placing portions of the first substrate 1120 within the engagement slots. Here, two sets of engagement slots 455 and 465 are illustrated. Again, in the illustrated embodiment, the first substrate is 1120 affixed to the shell 1110 by placing portions of the first substrate 1120 within the first set of engagement slots 455.

A second set of engagement slots 465 is used to affix a second substrate 1160 to the shell 1110. Electrical components 463 are mounted on the second substrate 1160. The electrical components 463 are connected to the lighting elements 220 of the first substrate 1120. The electrical components 463 can include power conditioning circuitry such as diodes, resistors, and capacitors.

The shell 1110 defines an aperture 420 through which light from the lighting elements 220 is projected. The end jamb lighting module 1100 includes a reflector 470 positioned proximal to the aperture 420. The reflector 470 is adapted to reflect light from the lighting elements 220 in a desired direction. The reflector 470 may be constructed of shiny tape, metallized glass or plastic or the like, a metallic strip, or be applied by vapor deposition. Otherwise, a white or metallic finish casing of the shell 1110 may reflect enough light so as to not need an additionally mounted reflector.

The end jamb lighting module 1100 includes an optical cover 430 covering at least a portion of the aperture 470. In the illustrated embodiment, the optical cover 430, combined with the end caps 1130 and 1140, completely encloses the aperture 420. Each of the end caps 1130 and 1140 define a mounting hole 1132 and 1142 allowing the end jamb lighting module 1100 to be mounted to the display case 1000 using mounting devices such as, for example only, screws. The cover 430 may be glass, Plexiglas, or other optical clear or semi-clear material. If desired, the optical cover 430 may be configured to modify the light path and act as a lens, though it may also be advantageous in some applications to minimize and make uniform the optical cover thickness to reduce distortion and absorption.

The shell 1110 also includes a reflector flange portion 595 for supporting the reflector 470 adapted to reflect light from said lighting elements toward a desired direction. Alternatively, the shell may include a reflective surface 570 portion proximal to the aperture 420. In such case, the reflector 470 may not be needed.

The end jamb lighting module 1100 includes a quick-disconnect connector 1150 adapted to engage with a mated connector through which external electrical power is supplied to said first lighting module.

The end jamb lighting module 1100 includes a quick-disconnect connector 1150 adapted to engage with a mated connector through which external electrical power is supplied to said first lighting module.

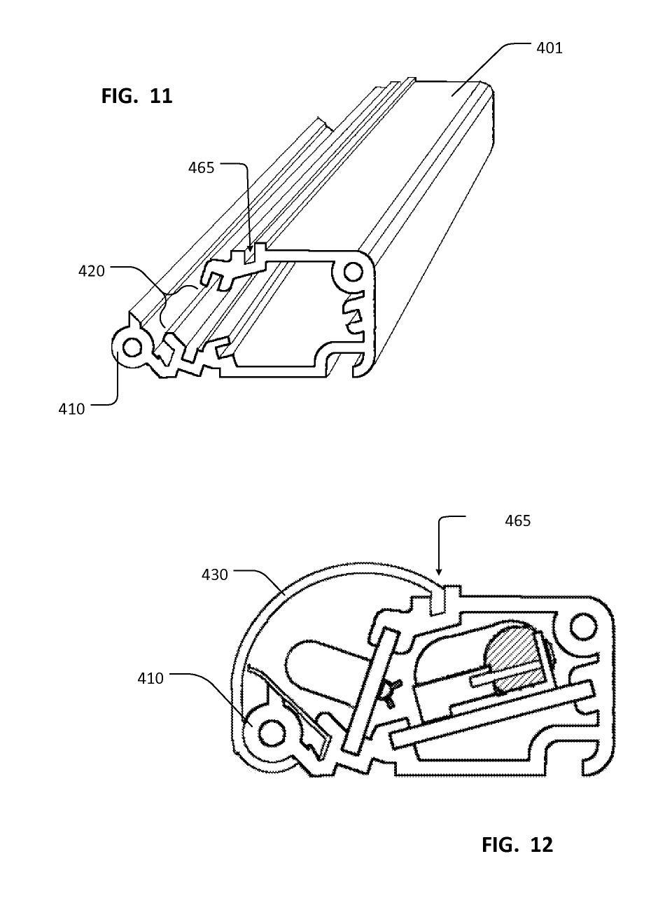

FIG. 11 illustrates an alternative embodiment 401 of the end jam module shell 1110 for the end jam lighting module 1100 of FIGS. 4 through 10. FIG. 12 is a cut-away cross sectional view of a lighting module of including shell 401. Most of the portions and the components of the lighting module of including shell 401 is similar to corresponding portions and corresponding components of the lighting module 1100 of FIGS. 4 through 10. However, the shell 401 of FIGS. 11 and 12 include some new features. For one, the shell 401 defines a cover tuck insert slot 465 proximal to the aperture 420. Edge of an optical cover 430 may be inserted to the tuck insert 465 for secure attachment. The opposing edge of the optical cover 430 can be secured by wrapping it, at least partially, around a cover flange portion 410 of the shell. In the illustrated embodiment, the cove flange portion 410 also functions as an encircling material 410 for a hole that is a fastener receiver 405. That is, the cover flange 410 defines a hole 405 that receives mounting screws 320 (of FIGS. 6 through 8) of the end plates 1130 and 1140 thereby allowing attachment of the end plates 1130 and 1140 to the shell 401.

### Center Mullion Lighting Module

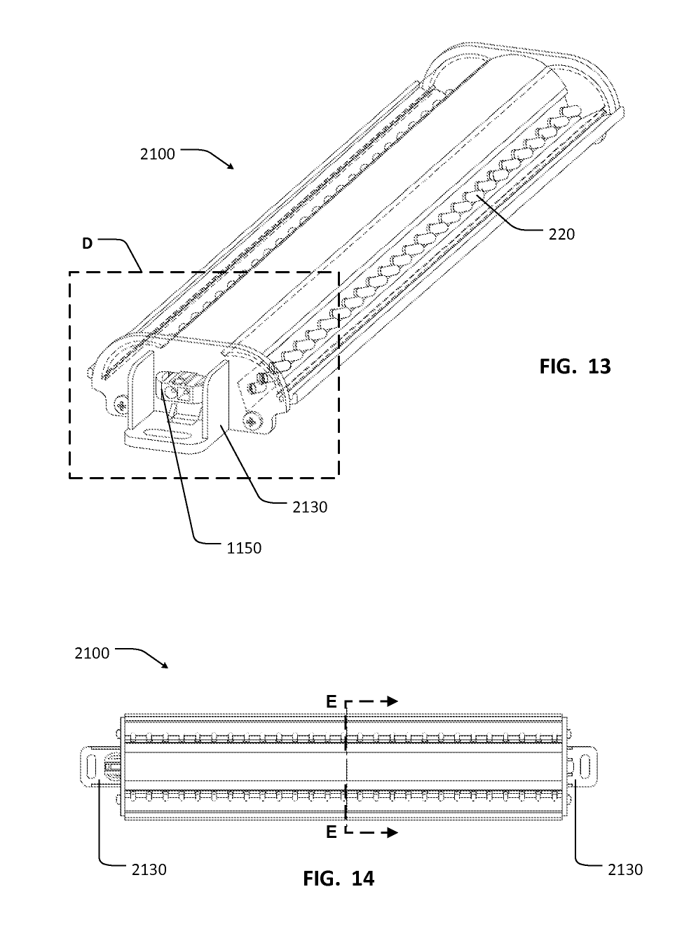

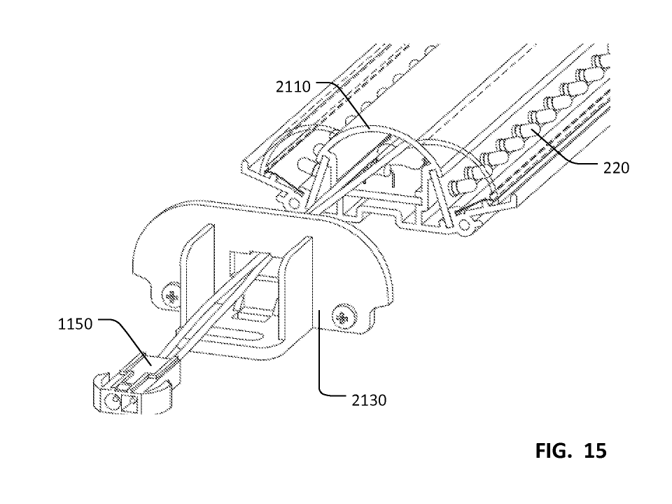

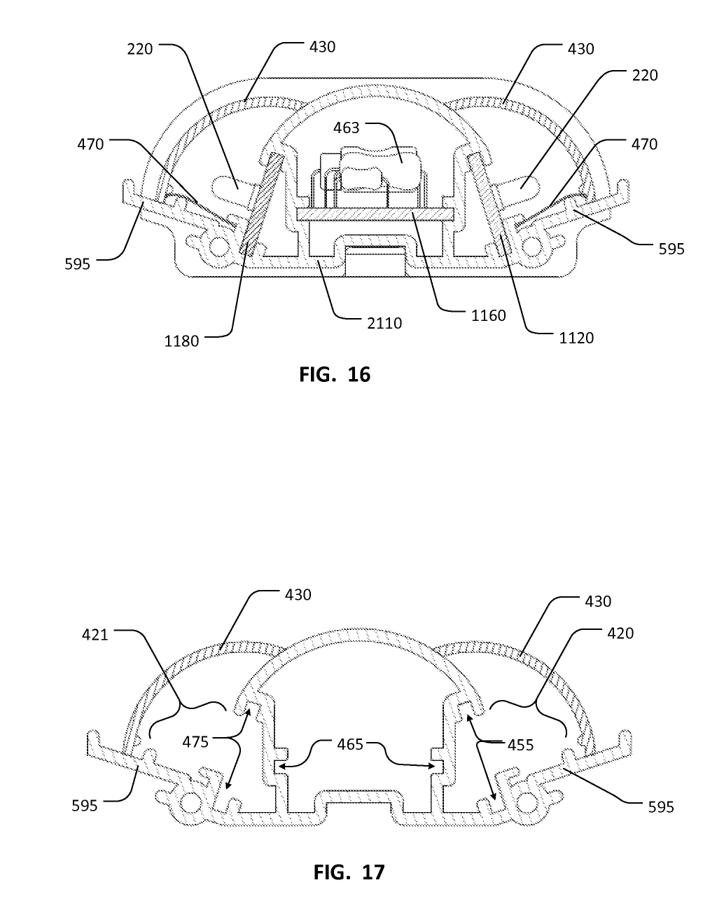

FIG. 13 is a perspective view of a center mullion lighting module 2100 in accordance with another embodiment of the present invention. FIG. 14 is a top view of the lighting module of FIG. 13. FIG. 15 is an exploded illustration of portion D of the lighting module of FIG. 13. FIG. 16 is a cut-away cross sectional view of the lighting module of FIG. 13 cut at line E-E. FIG. 17 is a cut-away cross sectional view of the lighting module of FIG. 13 cut at line E-E but showing only selected portions of the lighting module 2100.

The center mullion lighting module 2100 is a modified version of the end jamb lighting module 1100 of FIG. 4 through 10, modified to provide light in multiple directions. For this reason, many portions of the center mullion lighting module 2100 is similar to corresponding portions of the end jamb lighting module 1100 of FIG. 4 through 10.

Referring to FIGS. 13 through 17, the lighting module 2100 includes the first substrate 1120 having lighting elements 220 mounted on it. The lighting module 2100 also includes the second substrate 1160 having electrical components 463 mounted on it. The electrical components 463 are connected to the lighting elements 220 of the first substrate 1120. The lighting module 2100 includes a third substrate 1180 that is configured similarly to the first substrate 1120. The third substrate 1180, a printed circuit board (PCB), also has lighting elements 220 mounted on it.

These substrates 1120, 1160, and 1180 are affixed to a central mullion lighting module shell 2110. The shell 2110, similar to the shell 1110 (of FIGS. 4 through 10) define a plurality of engagement slots 455, 465, and 475 to which the substrates 1120, 1160, and 1180 are inserted. Again, similar to the lighting module 1100, the lighting module 2100 includes reflector flanges 595, reflectors 470, and optical covers 430. In this configuration, the central mullion lighting module 2100 provides light in at least two directions—the first direction by light provided through a first aperture 420, and the second direction by light provided through a second aperture 421.

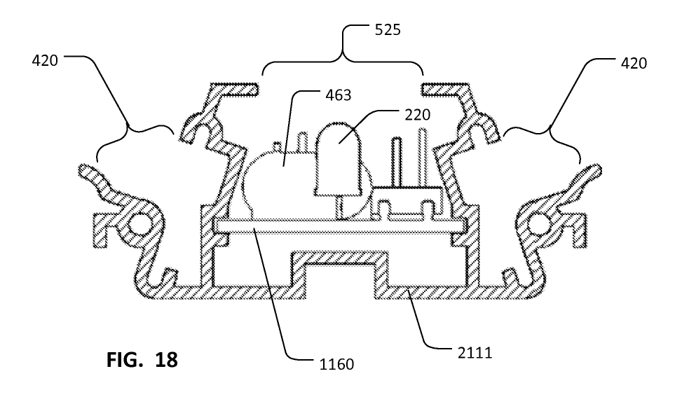

In an alternative embodiment of the central mullion lighting module shell 2110, the central mullion lighting module 2100 can be configured to provide light in three directions. FIG. 18 illustrates an alternate central mullion lighting module shell 2111 defining a third aperture 525. Furthermore, in this alternative embodiment, the second substrate 1160 is populated with light emitting elements 220 in addition to the electrical components 463.

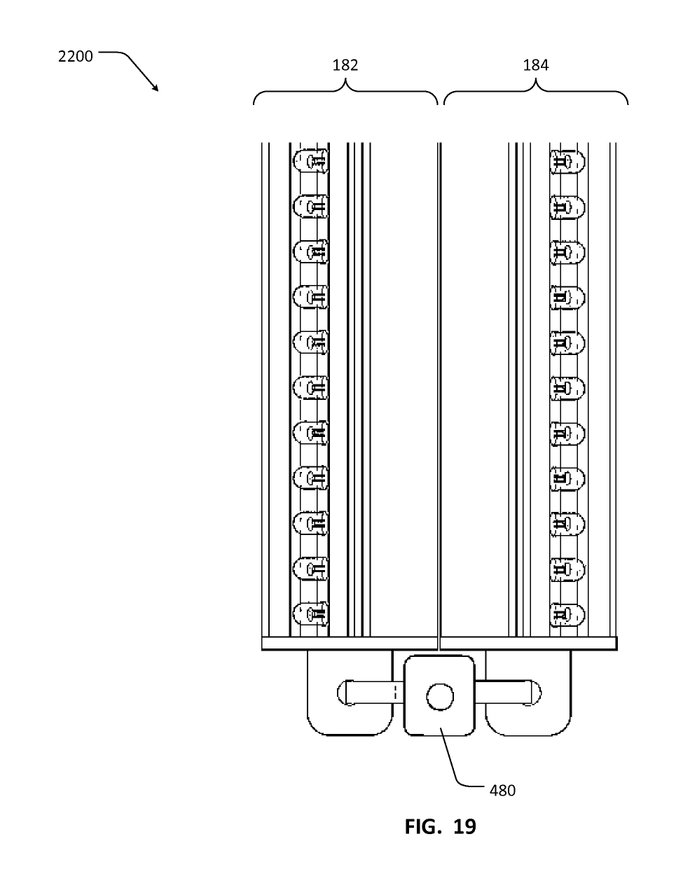

In another alternative embodiment of the central mullion lighting module 180 (of FIGS. 1 and 2), the central mullion lighting module 180 can be configured as two end jamb lighting modules 1100 (of FIGS. 4 through 10) mounted side-by-side on the center mullion 114. FIG. 19 illustrates the alternative embodiment 2200 of the central mullion lighting module 180 configured as two end jamb lighting modules 182 and 184.

Referring to FIGS. 1, 2, and 19, each of these end jamb lighting modules 182 and 184 has the same configuration as the end jamb lighting modules 1100 (of FIGS. 4 through 10). A clip 480 can be used to hold the lighting modules 182 and 183 side-by-side. In this configuration, the display case 1000 essentially has four end jamb lighting modules—the first end jamb lighting module 170, the second end jamb lighting module 190, the third end jamb lighting module 182, and the fourth end jamb lighting module 174. The third and the fourth end jamb lighting modules 182 and 184 are positioned to face different directions.

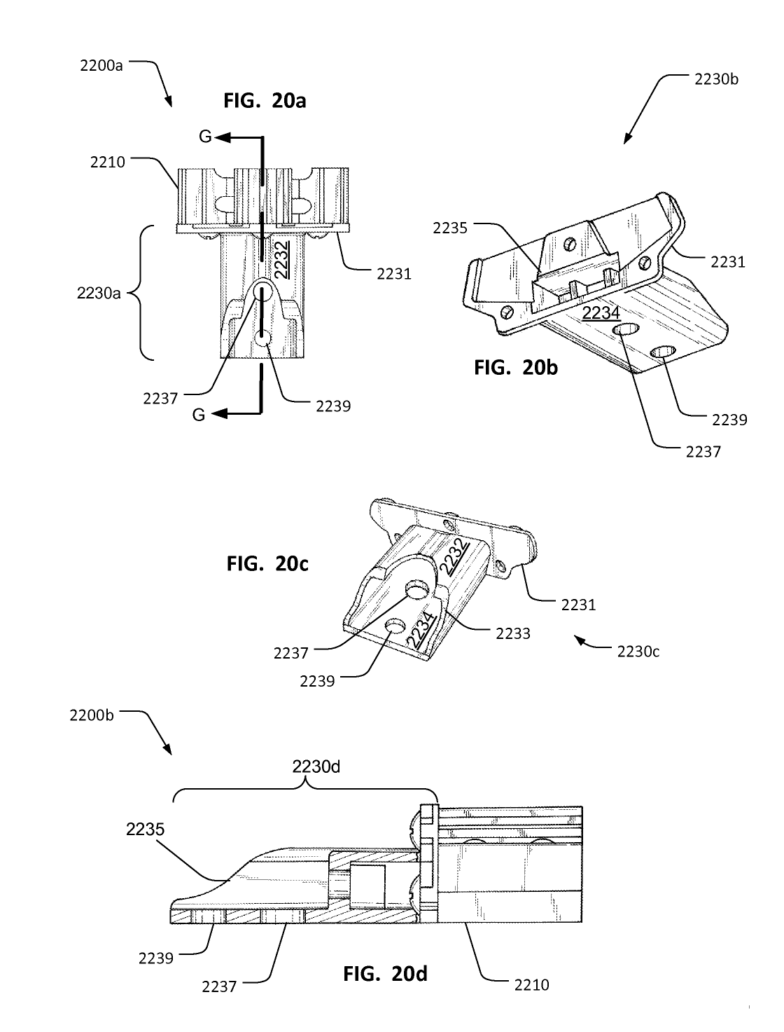

The lighting module end portion embodiment as in portion 1100 of FIGS. 4 and 8 is not the only possible embodiment. FIGS. 20 through 22 show various stages in construction of an alternative embodiment lighting module end portion.

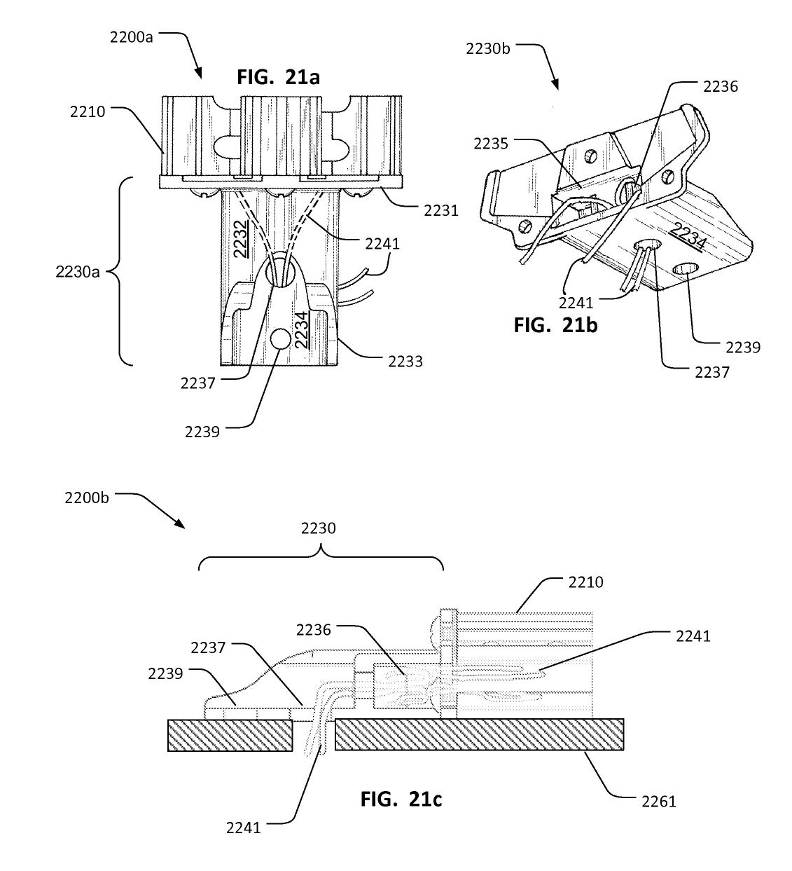

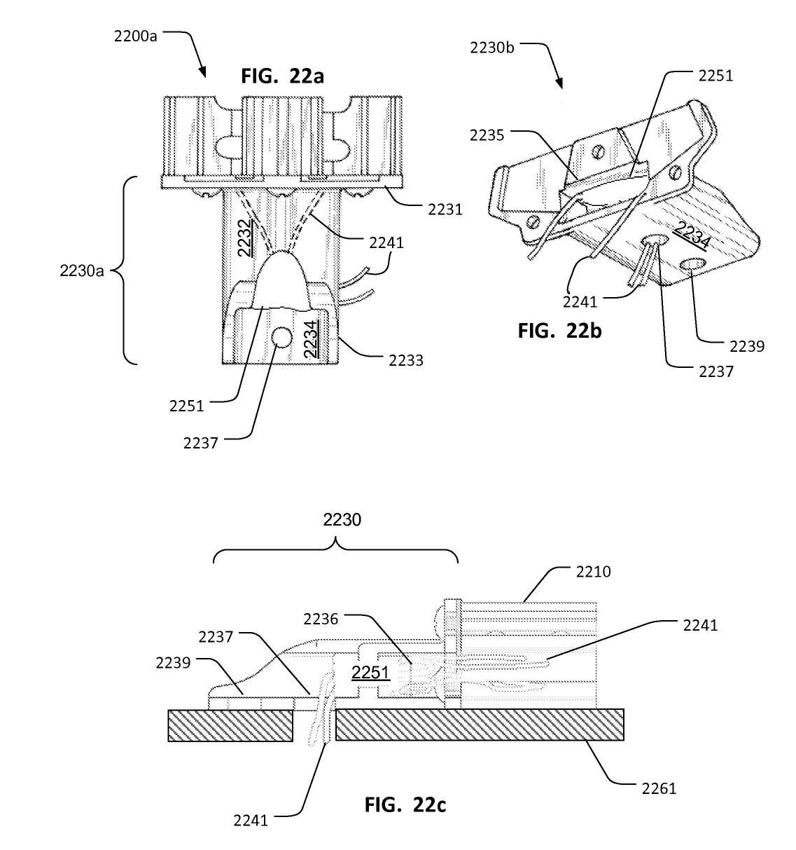

To detail FIG. 20a, plan view of module end portion 2200 shows an end cap 2230 adjoining shell portion 2210 of a module. This alternative module design 2200 features an end cap 2230 with a wiring hole 2237 and a mounting hole 2239. As shown in FIGS. 21 and 22, in particular, hole 2237 allows egress of wires from central pathway 2235 toward a mounting surface 2261.

To clarify terminology, the end cap 2230 may be characterized as including an end plate region 2231 for contact with a lighting module shell 2210, a transitional region 2232, and a foot region 2224 for purposes including support on an external structure. To further clarify, end cap detail 2233 of FIG. 20a represents a bevel 2233 along the transition 2232 from the end plate region 2231 to foot region 2234.

An end cap 2230b perspective view in FIG. 20b, features holes 2237, 2239, and 2235, the latter for accommodating wiring. Another perspective view of an end cap 2230c, in FIG. 20c shows cross section G-G, which is featured in FIG. 20d along with an end portion of a lighting module.

FIGS. 21 and 22 show buildups from the end cap 2230 and combined structure 2200 shown in FIG. 20. In FIG. 21, wiring 2241 is added to illustrate a routing concept. In FIG. 22, a material fill-in 2251 along with the wiring 2241 is shown to make the wiring route more robust.

In contrast with FIGS. 20 through 22, FIGS. 4 and 8 feature routing for wiring 1141 that protrude from the lighting module 1100 via end cap 1130. This wiring then routes to the connector 1150. A terminal point at which connector 1150 plugs in is not shown in FIG. 4 or 8 because in that embodiment, routing where to plug in is a decision for the display case builder or end user.

However, freely routing emerging wiring 1141 from a module portion 1100′ as in FIG. 8 can be problematic. In addition to being aesthetically unappealing, exposed wiring also create risks for accidents or tampering, or simply takes up extra wire material to route a longer distance.

Returning to FIGS. 20-22, modified end cap 2230 provides a cavity 2235 through which (in FIGS. 21-22) wiring 2241 may be routed to a second hole or aperture 2237 for directing the wiring in the direction of a mounting surface 2261.

FIGS. 21b and 21c show an optional post 2236 around which at least one wire 2241 may be wrapped to further secure its location within end cap 2230.

To further secure the wiring 2241, a material 2251 such as epoxy, RTV (Room Temperature Vulcanization) silicone, or other suitable sealing material may be used to fill the routing cavity 2235 once the wiring 2241 is in place, as shown in FIG. 22.

As shown in FIGS. 20 through 22, the cross section of end cap 2230 facing the shell 2210 may vary from the cross section of end cap 1130 shown in FIGS. 4 and 8. The key feature that distinguishes end cap 2230 is at least one extra hole 2237 exists beyond mounting hole 2239, to accommodate wiring (not shown in FIG. 20) to the end cap foot 2233.

As shown in FIGS. 21 and 22, the pathway from wiring 2241 to or through secondary hole 2237 may require a mounting configuration suitable so as not to obstruct wiring 2241 in passage through the hole 2237. In other words, any solid material that might otherwise be used as an anchor or mounting point for a fastener at hole 2239 must be configured so as not to obstruct a wire or wires going through hole 2237. FIG. 22 illustrates the need for a gap in a mounting surface 2261, for passing a wire or wires 2241. The illustration of mounting surface 2261 is to show a possible context of lighting system use only. Hypothetical mounting surface 2261 is not in itself part of the invention. The invention can work with arbitrary mounting surface variations, as long as the external mounting arrangement allows wire passage.

As a result, the modified wiring support and system shown in FIGS. 20-22 provides a routing path so as to protect and cover wiring leads that might otherwise be exposed to the product containment part of a cabinet where lighting modules are intended to be used.

Further, use of this wiring routing technique with a central mullion configuration is possible, especially in that an extra hole in an end cap may be used to route wiring if needed. More than one end cap hole may exist, for example in parallel to accommodate separate wires. Also, a hole in the sense of end cap material completely encircling wires may not be the only configuration to help with wire routing.

Advantages of this modified end portion design may include less wire fatigue and less material needed to make the wires.

### CONCLUSION

From the foregoing, it will be appreciated that the present invention is novel and offers advantages over the current art. Although a specific embodiment of the invention is described and illustrated above, the invention is not to be limited to the specific forms or arrangements of parts so described and illustrated. For example, differing configurations, sizes, or materials may be used to practice the present invention. The invention is limited by the claims that follow.

What is claimed is:

1. A display case comprising:
panels defining at least partially enclosed space, said display case having a first end jamb;
a first end jamb lighting module running along the first end jamb;
said first end jamb lighting module comprising:
a lighting module shell;
a first substrate affixed to said shell; and
lighting elements mounted on said first substrate;
wherein said panels define a second end jamb and a center mullion, the display case further comprising:
a second end jamb lighting module running along the second end jamb;
a center mullion lighting module running along the center mullion;
wherein said second end jamb lighting module comprises:
a shell;
a first substrate affixed to said shell; and
lighting elements mounted on said first substrate;
wherein said center mullion lighting module comprises:
a third end jamb lighting module oriented in a first direction; and
a fourth end jamb lighting module mounted proximal to said third end jamb lighting module,
said fourth end jamb module oriented in a second direction.

2. A display case comprising:
panels defining at least partially enclosed space, said display case having a first end jamb;
a first end jamb lighting module running along the first end jamb;
said first end jamb lighting module comprising:
a lighting module shell;
a first substrate affixed to said shell; and
lighting elements mounted on said first substrate;
wherein said panels define a second end jamb and a center mullion, the display case further comprising:
a second end jamb lighting module running along the second end jamb;
a center mullion lighting module running along the center mullion;
wherein said second end jamb lighting module comprises:
a shell;
a first substrate affixed to said shell; and
lighting elements mounted on said first substrate;
wherein said center mullion lighting module comprises:
a shell;
a first substrate affixed to said shell;
lighting elements mounted on said first substrate;
a second substrate affixed to said shell;
electrical components mounted on said second substrate, said electrical components connected to the lighting elements of said first substrate;
a third substrate affixed to said shell; and
lighting elements mounted on said third substrate.

3. A display case comprising:
panels defining at least partially enclosed space, said display case having a first end jamb;
a first end jamb lighting module running along the first end jamb;
said first end jamb lighting module comprising:
a lighting module shell;
a first substrate affixed to said shell; and
lighting elements mounted on said first substrate;
\wherein said first end jamb lighting module further comprises:
a second substrate affixed to said shell; and
electrical components mounted on said second substrate, said electrical components connected to the lighting elements of said first substrate.

4. A display case comprising:
panels defining at least partially enclosed space, said display case having a first end jamb;
a first end jamb lighting module running along the first end jamb;
said first end jamb lighting module comprising:
a lighting module shell;
a first substrate affixed to said shell;
lighting elements mounted on said first substrate;
a second substrate affixed to said shell; and
electrical components mounted on said second substrate, said electrical components connected to the lighting elements.

5. The display case recited in claim 4 wherein said shell defines a plurality of engagement slots such that said first substrate is affixed to said shell by placement of portions of said first substrate within a first set of engagement slots.

6. A display case comprising:
panels defining at least partially enclosed space, said panels also defining a first end jamb, a second end jamb, and a center mullion;
a first end jamb lighting module running along the first end jamb;
a second end jamb lighting module running along the second end jamb;
a center mullion lighting module running along center mullion;
wherein each lighting module comprises:
a lighting module shell;
a first substrate affixed to said shell;
lighting elements mounted on said shell;
a second substrate affixed to said shell; and
electrical components mounted on said second substrate, said electrical components connected to the lighting elements.

7. A lighting module comprising:
a lighting module shell,
a first substrate affixed to said shell;
lighting elements mounted on said first substrate;
a second substrate affixed to said shell;
electrical components mounted on said second substrate, said electrical components connected to the lighting elements; and
where said shell comprises a reflector flange portion for supporting a reflector adapted to reflect light from said lighting elements toward a desired direction.

8. A lighting module comprising:
a lighting module shell,
a first substrate affixed to said shell;
lighting elements mounted on said first substrate;
a second substrate affixed to said shell;
electrical components mounted on said second substrate, said electrical components connected to the lighting elements; and
where said shell comprises a reflector flange portion adapted to reconfigure the spatial distribution of light from said lighting elements.

9. A lighting module comprising:
a lighting module shell,
a first substrate affixed to said shell;
lighting elements mounted on said first substrate;
a second substrate affixed to said shell;
electrical components mounted on said second substrate, said electrical components connected to the lighting elements;
where said shell defines a cover flange;
said shell defines a tuck insert; and
an optical cover partially wraps around said cover flange and edge of said optical cover is inserted into the tuck insert.

10. An end cap for routing wires from a lighting module shell to a support structure, the end cap comprising:
a first surface for attachment to the lighting module shell;
a second surface for attachment to the support structure;
a transition structure defining at least one cavity in between said first surface and said second surface; and
wherein at least one wire may be routed from the lighting module shell through the cavity toward the support structure.

11. The end cap as in claim 10, further comprising:
a post around which wire may be wrapped.

12. The end cap as in claim 10, further comprising:
wire routed through the transition structure; and
a filler material to fill the cavity along with the wire in the transition structure.

13. A lighting module built with an end cap as in claim 10.
